(19) United States
(12) Patent Application Publication
(10) Pub. No.: US 2003/0111944 A1
(43) Pub. Date: Jun. 19, 2003

(54) Bulb attachment for temperature limited environment

(76) Inventor: Vildana Jahic, Cerritos, CA (US)

Correspondence Address: COUDERT BROTHERS LLP, 333 SOUTH HOPE STREET, 23RD FLOOR, LOS ANGELES, CA, 90071, US

(21) Appl. No.: 10/017,686

(22) Filed: Dec. 13, 2001

(51) Int. Cl. H01J 7/24; H01J 61/52

(52) U.S. Cl. 313/44

(57) ABSTRACT

The present invention provides a bulb attachment for a temperature limited environment. According to the invention, a sleeve is attached to a bulb in a bulb/reflector assembly. As the lamp operates, heat is diverted from the hottest portions of the bulb and into the sleeve, which results in a lower surface temperature of the bulb and allows compliance with UL standards. In some cases, the use of the sleeve allows for the use of higher power bulbs (and the associated increases in light output and brightness) without violating UL standards.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The present invention relates to light sources, and in particular to a bulb attachment designed for use in temperature limited environments.

2. Background Art

Incandescent lamps generally refer to any of the various devices that produce light by heating a suitable material to a high temperature. Incandescent lamps fall under the regulatory authority of the Underwriter's Laboratory (UL). The UL sets standards that define the maximum surface temperature of the bulb of an incandescent lamp used in a safety critical environment. Limiting the temperature of the bulb, yet still providing an acceptable amount of light is a difficult problem for manufacturers to solve. Before discussing this problem, an overview is provided.

Incandescent Lamps

Incandescent lamps produce light by heating a suitable material to a high temperature. When any solid or gas is heated, commonly by combustion or resistance to an electric current, it gives off light of a color characteristic of the material (spectral balance).

Flashlights

Flashlights often use incandescent bulbs and are often used by firefighters and others in safety critical situations. A flashlight is a relatively simple device consisting of a body, bulb, lens-cap assembly, reflector, battery and switch.

Various flashlight designs are known in the art. Flashlights include one or more dry cell batteries and in certain designs the batteries are arranged in series in a battery compartment of a barrel or tube which acts as a handle for the flashlight. Electrical energy from the batteries is generally conducted to a lamp or bulb at the front end of the flashlight through a switch mechanism positioned between the batteries and the lamp.

The UL sets restrictions on the maximum surface temperature of the bulb of a flashlight in safety critical situations where there is the presence of propane, methane, or other flammable gasses. Some situations include, for instance, fire fighting, the use of lighting in mines, and the use of lighting for medical applications. In particular, the UL requires that the surface of the bulb must be less than 160 degrees centigrade.

Manufacturers must find bulbs for use in flashlights that meet the UL standards for safety critical applications. Often, bulbs that meet the UL standards for surface temperature are lower power bulbs that don't provide adequate light. This solution, however, is inadequate because often in critical situations, there is a need for a very bright light source. Such a need is in conflict with the UL requirements and makes it difficult for light source manufacturers to produce a compliant, yet reasonably bright light source.

### SUMMARY OF THE INVENTION

The present invention provides a bulb attachment for a temperature limited environment. According to the invention, a sleeve is attached to a bulb in a bulb/reflector assembly. As the lamp operates, heat is diverted from the hottest portions of the bulb and into the sleeve, which results in a lower surface temperature of the bulb and allows compliance with UL standards. In some cases, the use of the sleeve allows for the use of higher power bulbs (and the associated increases in light output and brightness) without violating UL standards.

In one embodiment, the sleeve is integrated into an incandescent bulb/reflector combination. The sleeve may be coupled to the bulb directly or it may be attached using a notch in the sleeve that fits into the reflector. In the case where the sleeve attaches to the reflector via a notch, any standard bulb may be inserted into the sleeve-reflector combination. In one embodiment, the sleeve is comprised of a metal, copper or brass for example, and is located substantially in a lower portion of the bulb.

When a reflector is used in combination with a bulb and a sleeve (e.g., in a flashlight), the reflector may be comprised of plastic or aluminum. Aluminum and other metal reflectors can act as a heat sink and assist in lowering bulb surface temperature. However, aluminum and other metal reflectors are expensive. Plastic reflectors are less expensive than metal reflectors. However, because plastic reflectors do not provide heat sink capabilities, surface temperatures of bulbs used with plastic reflectors are higher than those used with metal reflectors. With either application, however, the sleeve acts to divert heat from the hottest parts of the lamp.

### BRIEF DESCRIPTION OF THE DRAWINGS

These and other features, aspects and advantages of the present invention will become better understood with regard to the following description, appended claims and accompanying drawings where:

FIG. 1 is a diagram showing an embodiment of the present invention.

FIG. 2 is a diagram showing an alternate embodiment of the present invention.

FIG. 3 is a diagram showing another embodiment of the present invention.

### DETAILED DESCRIPTION OF THE INVENTION

The invention is a bulb attachment for use in a temperature limited environment. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Bulb Attachment

The present invention provides a bulb attachment for use in a temperature limited environment. According to the invention, a sleeve is attached to a bulb to provide a heat sink. During lamp operation, heat is conducted from the bulb and into the sleeve, which results in a lower surface temperature of the bulb and provides compliance with UL standards. In some cases, the use of the sleeve allows for the use of a higher power bulb (and the associated increases in light output and brightness) without violating UL standards.

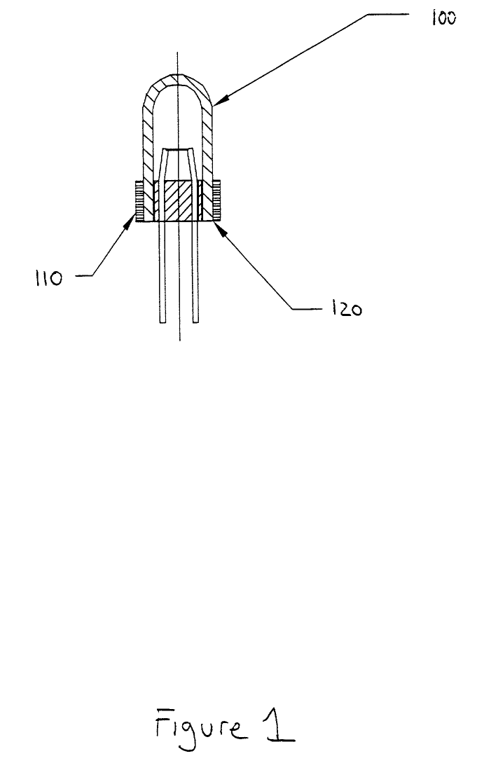

FIG. 1 shows one embodiment of the present invention. Bulb 100 includes a sleeve 110. Sleeve 110 is attached to bulb 100 using an attaching mechanism 120, which can be a press fit or coupled to the bulb using adhesive cement. The sleeve is comprised of a metal, copper or brass for example, and is located substantially in a lower portion of the bulb 130.

Bulb, Sleeve, and Reflector Combination

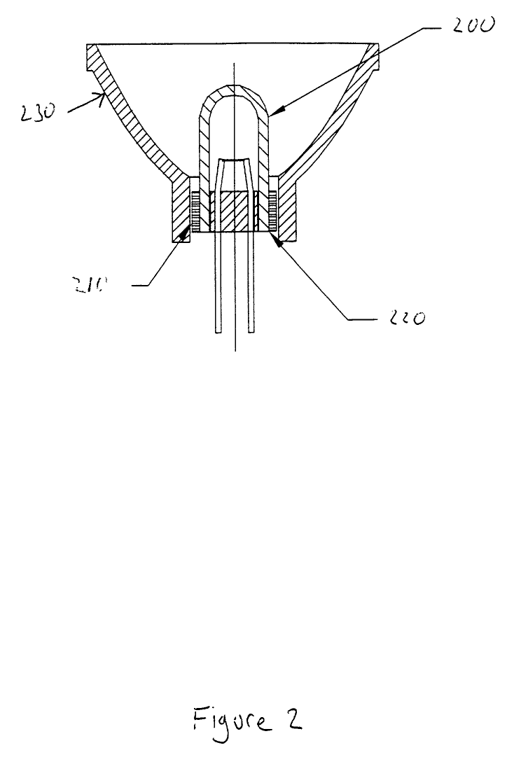

FIG. 2 shows an alternate embodiment of the present invention providing a bulb, sleeve, reflector combination, such as may be used in flashlights and other lighting instruments that use reflectors. When a reflector is used in combination with a bulb and a sleeve (i.e., a flashlight), the reflector may be comprised of plastic or aluminum.

Bulb 200 has a sleeve 210 connected to it using an attaching mechanism 220. Reflector 230 is attached to an outer portion of the sleeve 210. Regardless of the metal that is used for the sleeve, it may be nickel plated to provide a more reflective surface and to match the surface of the reflector 230. As seen in FIG. 2, the sleeve is disposed about the base of the bulb 200. The sleeve may contact a lower portion of the glass of the bulb to provide conductive heat transfer away from the bulb, resulting in lower bulb surface temperatures. When used with a plastic reflector, the sleeve can lower bulb surface temperature sufficiently to allow the use of higher power bulbs than would be possible without the use of the sleeve. This advantage becomes more dramatic when used with a metal reflector.

Notched Sleeve

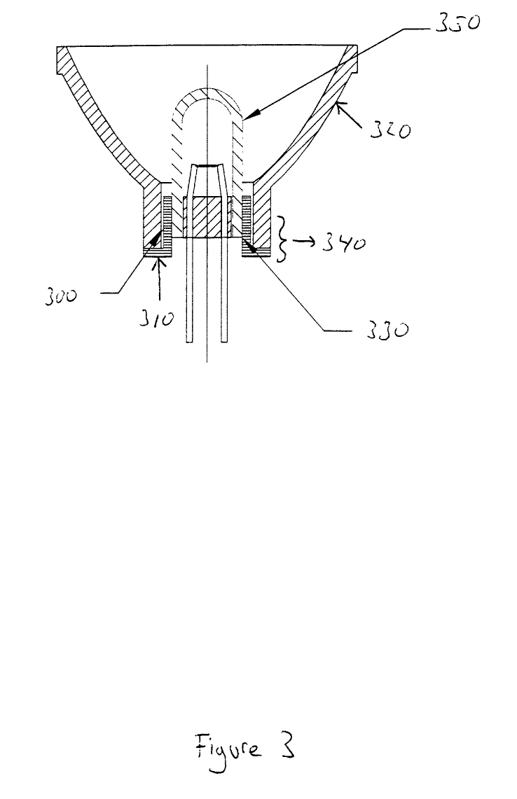

In one embodiment, the sleeve couples to the bulb using a notch in the sleeve that attaches to the reflector. In the embodiment, any standard bulb may be inserted into the sleeve-reflector combination. FIG. 3 shows an embodiment that uses a notched sleeve. Sleeve 300 has a notch 310. Reflector 320 is attached to sleeve 300 at notch 310 where an attaching mechanism 330 is applied. The attaching mechanism is a press fit, adhesive cement or other suitable attaching mechanism. The reflector-sleeve combination 340 is configured to attach directly to bulb 350, which can be any standard incandescent bulb.

Case Study

Tests were performed to verify the use of the present invention. In one test a plastic reflector was used. The room temperature was measured to be 22.5 degrees centigrade and commercially available batteries were used. The temperature at various times was measured with the inclusion of a brass sleeve. After a period of continuous operation, the surface temperature of the bulb reached approximately 140 degrees centigrade, well within UL standards. In another test, a second plastic reflector was used. The room temperature was measured to be 22.5 degrees centigrade. In this second test, the maximum temperature reached 149.8 degrees after 19 minutes, also well within UL standards. In another test, the first plastic reflector from the test of table 1 was used in a different location. The room temperature was measured to be 23.3 degrees centigrade. The temperature at various times was measured with the inclusion of a brass sleeve. In this third test, the maximum temperature reached 144.4 degrees after 21 minutes, well within UL standards. In another test, a third plastic reflector was used without a brass sleeve. The room temperature was measured to be 22.3 degrees centigrade. In this test, without the sleeve, the surface temperature of the bulb reached 165 degrees centigrade, outside the acceptable UL range.

Thus, a bulb attachment for a temperature limited environment is described in conjunction with one or more specific embodiments. The invention is defined by the claims and their full scope of equivalents.

1. A bulb assembly comprising:
a bulb;
a metal sleeve coupled to a portion of said bulb.

2. The assembly of claim 1 wherein said metal sleeve is comprised of a brass.

3. The assembly of claim 2 wherein said metal sleeve is plated with a nickel.

4. The assembly of claim 1 wherein said sleeve is coupled to said bulb via a press fit.

5. The assembly of claim 1 wherein said sleeve is coupled to said bulb via adhesive cement.

6. An assembly comprising:
a bulb;
a sleeve coupled to said bulb;
a reflector coupled to said sleeve.

7. The assembly of claim 6 wherein said sleeve includes a notch to attach said sleeve to said reflector using an attaching mechanism.

8. The assembly of claim 6 wherein said sleeve is comprised of a metal.

9. The assembly of claim 8 wherein said metal is brass plated with nickel.

10. The assembly of claim 7 wherein said sleeve is coupled to said bulb via a press fit.

11. The assembly of claim 7 wherein said sleeve is coupled to said bulb via adhesive cement.
